(19) United States
(12) Patent Application Publication
(10) Pub. No.: US 2010/0128379 A1
(43) Pub. Date: May 27, 2010

(54) GUIDE ASSEMBLY FOR REDUCING LATERAL TAPE MOTION IN A TAPE DRIVE

(75) Inventors: John Ycas, Boulder, CO (US); Clark Janssen, Loveland, CO (US)

Correspondence Address: James P. Broder;Roeder & Broder LLP, 9915 Mira Mesa Blvd. Suite 300, San Diego, CA, 92131, US

(73) Assignee: QUANTUM CORPORATION

(21) Appl. No.: 12/277,065

(22) Filed: Nov. 24, 2008

(51) Int. Cl. G11B 17/00

(52) U.S. Cl. 360/71

(57) ABSTRACT

A guide assembly (22) for guiding movement of a tape (26) past a head assembly (16) in a tape drive (10) includes a rotatable roller (36A) and a non-rotatable tape guide (38). The rotatable roller (36A) and the tape guide (38) each guides the tape (26) along the tape path (29). In certain embodiments, both the tape guide (38) and the head assembly (16) are positioned to contact a first side (30) of the tape (26). Further, the tape guide (38) is positioned between the rotatable roller (36A) and the head assembly (16) relative to the tape path (29). The tape guide (38) can include a first flange (348B-348F) that contacts the tape (26) during movement of the tape (26) along the tape path (29). The tape guide (38) can be positioned more closely to the head assembly (16) than the tape guide (38) is to the rotatable roller (36A). The tape (26) can form a tape wrap angle (240A, 240B) relative to the tape guide (38) that is less than approximately 20 degrees. The tape guide (38) can be positioned less than approximately 5 mm from the head assembly (16). The tape path (29) is uninterrupted between the rotatable roller (36A) and the tape guide (38).

### BACKGROUND

Magnetic storage tapes are commonly used to store relatively large amounts of information in digital form. These storage tapes, also known as cartridges, have become increasingly efficient to use due to their low cost, portability, and substantial storage capacity. In contrast to hard disks that are relatively inaccessible within the hard disk drive assembly, the cartridge is easily removed from a tape drive, and can be economically transferred to remote locations for use in another tape drive. A typical cartridge includes a tape having a substrate, a coating of magnetic recording material on one side of the substrate, and a high durability “back coating” on the other side of the substrate. The tape drive includes a head assembly that transfers data to and from the tape. For multi-track tape drives, the head assembly includes a tape head that can move to the appropriate vertical location along the width of the tape for reading data from and/or writing data to a particular track on the tape.

In one type of tape drive, the tape runs between a supply reel within the cartridge and a take-up reel within the tape drive. A guide assembly, which typically includes a set of tape rollers, guides the tape along a tape path that passes across the head assembly. This type of guidance must be performed accurately and consistently to avoid lateral tape motion (“LTM”), which can lead to data reading and writing errors. “Lateral tape motion” is defined herein as any deviation from the perfect plane path of the tape near the head assembly as the tape travels between the supply reel to the take-up reel, in either direction. One measure of LTM is the peak-to-peak distance that the tape moves perpendicular to a prescribed longitudinal direction of motion of the tape past the head assembly.

Causes of LTM can include planar misalignment of the cartridge, the rollers, and or the take-up reel relative to one another. In addition, rotating components in the tape drive, such as the cartridge reel, the take-up reel, guide rollers, etc., can contribute to LTM. Further, any surface condition or anomaly that tends to inflict a deviation from the perfect path can cause LTM. For example, surface conditions resulting from roller design or contamination and vibration can result in excessive LTM. In addition, thinner tape tends to be less rigid than thicker tape, which can lead to decreased control over movement of the tape 26. Because cartridges are currently manufactured using relatively thin tape, i.e. 0.5 mil or less, preventing LTM has become increasingly difficult. Decreasing perpendicular misalignment in all directions has been used to reduce LTM. Other attempts at reducing LTM include increasing the mechanical precision of rotating structures within the tape drive.

In certain tape drives, the positioning and type of rollers used in the guide assembly can cause a condition that is known as “directional continuity shift” (also sometimes referred to herein as “DC shift”). DC shift can occur when orientation of the rollers and/or a groove pattern on the rollers tends to cause the tape to move laterally in one direction, i.e. perpendicular to the direction of the moving tape. Reversal of the tape direction then causes an abrupt change in the lateral tape motion, so that the tape is moving laterally in the opposite direction. The result of DC shift is that a track of data in one direction is not at the precise vertical location when read in the opposite direction.

Today's cartridges utilize tape with more densely positioned data tracks. Tape drives attempt to precisely register data tracks using servo tracks and servo systems. By positioning the tracks closer together, more data can be stored in a given length of tape. The addition of more tracks leads to a decrease in the physical separation between the tracks, thereby lowering the “guard band” or margin of safety between the tracks. A lower guard band requires a decreased LTM and/or DC shift during operation in order to reduce reading and writing errors.

### SUMMARY

The present invention is directed toward a guide assembly for guiding movement of a tape past a head assembly in a tape drive. The tape moves along a tape path, with the tape having a first side that contacts the head assembly, and an opposing second side. In one embodiment, the guide assembly includes a rotatable roller and a non-rotatable tape guide. The rotatable roller and the tape guide each guides the tape along the tape path. In certain embodiments, the tape guide is positioned to contact the first side of the tape. Further, the tape guide is positioned between the rotatable roller and the head assembly relative to the tape path.

In some embodiments, the tape guide includes a first flange that contacts the tape during movement of the tape along the tape path. The tape drive also includes a housing. The tape guide includes a proximal end that is secured to the housing. In one embodiment, the first flange is positioned near the proximal end. The tape guide also includes a distal end opposite the proximal end. In one embodiment, the tape guide can include a second flange that is positioned near the distal end. In accordance with one embodiment, the tape moves along the tape path guided by the first flange and the second flange. In certain embodiments, the tape guide is positioned more closely to the head assembly than the tape guide is to the rotatable roller. In some embodiments, the tape guide is positioned less than approximately 5 mm from the head assembly. Further, the tape path can be uninterrupted between the rotatable roller and the tape guide. In one embodiment, the tape guide is movable in a direction that is approximately perpendicular to the direction of the tape path. Additionally, in one embodiment, the tape forms a tape wrap angle relative to the tape guide that is less than approximately 20 degrees.

The present invention is also directed toward a method for guiding a tape along a tape path across a head assembly in a tape drive.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top plan view of a portion of a tape drive-including a guide assembly having features of the present invention:

FIG. 2A is a simplified top view of a portion of a tape, a tape head and one embodiment of the guide assembly including a rotatable roller and a non-rotatable tape guide;

FIG. 2B is a simplified top view of a portion of a tape, a tape head and another embodiment of the guide assembly including a rotatable roller and a tape guide,

FIG. 3A is a side view of one embodiment of the tape guide;

FIG. 3B is a side view of another embodiment of the tape guide;

FIG. 3C is a side view of yet another embodiment of the tape guide;

FIG. 3D is a side view of still another embodiment of the tape guide;

FIG. 3E is a side view of another embodiment of the tape guide,

FIG. 3F is a side view of yet another embodiment of the tape guide;

FIG. 4A is a graph illustrating experimental results of position error signal over time using a prior art guide assembly; and

FIG. 4B is a graph illustrating experimental results of position error signal over time using one embodiment of the guide assembly having features of the present invention.

### DESCRIPTION

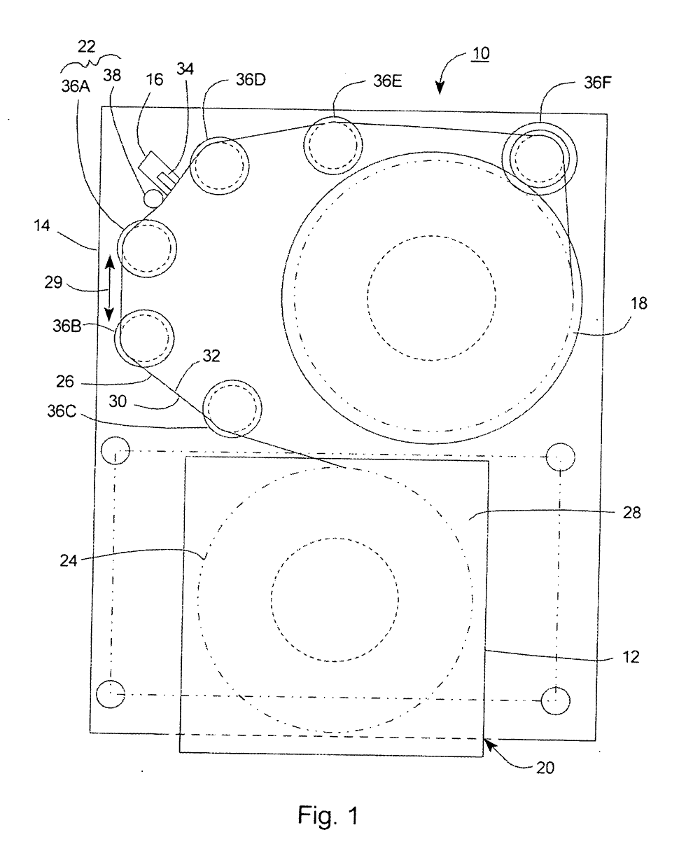

FIG. 1 is a top view of a portion of a tape drive 10 designed for use with a tape cartridge 12 (also referred to herein as “cartridge”). In one embodiment, the tape drive 10 includes a drive housing 14, a head assembly 16, a take-up reel 18, a cartridge receiver 20 (illustrated with dashed lines), and a guide assembly 22.

The design of the tape drive 10 can vary. A detailed description of various components of one embodiment of the tape drive 10 is provided in U.S. Pat. No. 5,371.638, issued to Saliba, and assigned to Quantum Corporation, the Assignee of the present invention. To the extent permitted, the contents of U.S. Pat. No. 5,371,638 are incorporated herein by reference. The drive housing 12 retains the various components of the tape drive 10.

The cartridge 12 can vary in size and shape. The cartridge 12 includes a cartridge reel 24, a storage tape 26 (sometimes referred to herein as “tape”) and a substantially rectangular cartridge housing 28 that encloses the cartridge reel 24 and the tape 26. During use, the cartridge 12 inserted into the cartridge receiver 20 of the tape drive 10.

In a typical cartridge 12, the tape 26 is positioned on the cartridge reel 24. The tape 26 stores data in a form so that the data can be subsequently retrieved. The tape 26 moves along a tape path 29 (as illustrated by arrow) between the cartridge reel 24 of the cartridge 12 and the take-up reel 18 of the tape drive 10. The specific angle and positioning of the tape path 29 varies within the tape drive 10 depending upon the positioning and configuration of the guide assembly 22 that guides the tape 26 within the drive housing 14. For example, arrow 29 is representative of the direction of the tape path 29 in one specific location within the tape drive 10. It is recognized that the orientation of arrow 29 changes along the length of the tape path 29 in other locations within the tape drive 10.

The tape 26 includes a first side 30 and an opposing second side 32. In one embodiment, one of the sides 30. 32 stores the data. In the embodiment illustrated in FIG. 1, the first side 30 directly faces and contacts the head assembly 16. Thus, in this embodiment, the first side 30 is configured to store data. It is recognized that in other embodiments, the second side 32 can additionally or alternatively be adapted to store data.

The drive housing 14 generally houses and/or surrounds the components within the tape drive 10.

The head assembly 16 is coupled or directly secured to the drive housing 14. The head assembly 16 includes a tape head 34 that reads data from and writes data to the tape 26. In one embodiment, the head assembly 16 can also include an actuator (not shown) that moves the tape head 34 in a direction that is approximately perpendicular to the direction of movement of the tape 26 along the tape path 29, i.e. in and out of the page in FIG. 1. With this design, the tape head 34 can adjust for slight variations in the position of the tape 26 when the tape moves along the tape path 29 across the tape head 34.

The guide assembly 22 guides the tape 26 along the tape path 29 past the head assembly 16 and onto the take-up reel 18. The guide assembly 22 inhibits lateral tape motion during operation of the tape drive 10, as described in greater detail below. In one embodiment, all or some of the guide assembly 22 is coupled or directly secured to the drive housing 14.

In one embodiment, the guide assembly 22 includes one or more tape rollers including at least a first roller 36A. In the embodiment illustrated in FIG. 1, the guide assembly 22 includes six rollers 36A-36F. However, the number of rollers 36A-36F can be varied to suit the design requirements of the tape drive 10. The design of the rollers 36A-36F can vary. In one embodiment, all of the rollers 36A-36F are rotatable. In another embodiment, some of the rollers 36A-36F can be rotatable, and some of the rollers 36A-36F can be fixed. Further, the rollers 36A-36F can be identical to one another, or one or more of the rollers 36A-36F can be different from one another. In one embodiment, at least roller 36A is rotatable.

As used herein, the “first roller 36A” is the one roller of the plurality of tape rollers 36A-36F that is most closely positioned to the head assembly 16 on a cartridge 12 side of the tape path 29 (as opposed to a take-up reel 18 side of the tape path 29). Stated another way, the first roller 36A is positioned between the head assembly 16 and the cartridge 12 relative to the tape path 29, with no other rollers 36B-36F being positioned between the first roller 36A and the head assembly 16 relative to the tape path 29.

In the embodiment illustrated in FIG. 1, the guide assembly 22 also includes a tape guide 38 that contacts and guides movement of the tape 26 along the tape path 29. The configuration of the tape guide 38 can be varied depending upon the design requirements of the guide assembly 22 and the tape drive 10. In certain embodiments, the tape guide 38 is non-rotatably mounted or coupled to the drive housing 14. With this design, any rotational vibration from the tape guide 38 is eliminated. In an alternative embodiment, the tape guide 38 can be rotatably mounted or coupled to the drive housing 14.

The positioning and configuration of the tape guide 38 causes a reduction in LTM as provided herein. In the embodiment illustrated in FIG. 1, the tape guide 38 is positioned substantially between roller 36A and the head assembly 16 relative to the tape path 29. In one embodiment, the tape guide 38 is positioned on the same side of the tape 26 as the head assembly 16. In other words, the tape guide 38 contacts the same side of the tape 26 as does the head assembly 16. In the embodiment illustrated in FIG. 1, the tape guide 38 contacts the first side 30 of the tape 26. With this design, the tape path 29 does not extend directly between the tape guide 38 and the head assembly 16.

In one embodiment, the tape guide 38 is positioned adjacent to the head assembly 16 to provide a relatively stable and/or substantially immobile surface that aligns and/or guides the tape 26 immediately adjacent to the tape head 34. For example, in accordance with one embodiment, the tape guide 38 can be positioned as close as possible to the head assembly 16 without being in contact with the head assembly 16. In one embodiment, the tape guide 38 is positioned more proximate the head assembly 16 than the tape guide 38 is to the first roller 36A. In non-exclusive alternative embodiments, the tape guide. 38 can be positioned less than approximately 5 mm, 4 mm, 3 mm, 2 mm, 1 mm, 0.5 mm or 0.1 mm from the head assembly 16. Due to the proximity of the tape guide 38 to the tape head 34, LTM disturbances that can be caused by the rollers 36A-36F or other structures along the tape path 29 are attenuated immediately prior to the tape 26 passing across the tape head 34. In alternative embodiments, the tape guide 38 can be positioned further than 5 mm from the head assembly 16.

Further, in one embodiment, the tape guide 38 is continuously in contact with the tape 26 during normal movement of the tape 26 along the tape path 29. With this design, any “bounce” associated with an initiation of contact between the tape guide 38 and the tape 26 is inhibited or eliminated completely. In another embodiment, the tape guide 38 can be movably positioned to selectively contact the tape 26 at certain times during operation of the tape drive 10, i.e. during reading and/or writing operations, for example. In this embodiment, the guide assembly 22 can include a guide actuator (not shown) that movably positions the tape guide 38 relative to the tape path 29, as necessary, based on the design requirements of the tape drive 10. For example, the guide actuator can move the tape guide 38 between a first position in which the tape guide 38 contacts the tape 26, and a second position in which the tape guide 38 is not in contact with the tape 26. The guide actuator can use any actuation means known to those skilled in the art for movement of structures within the tape drive 10 or other similar device.

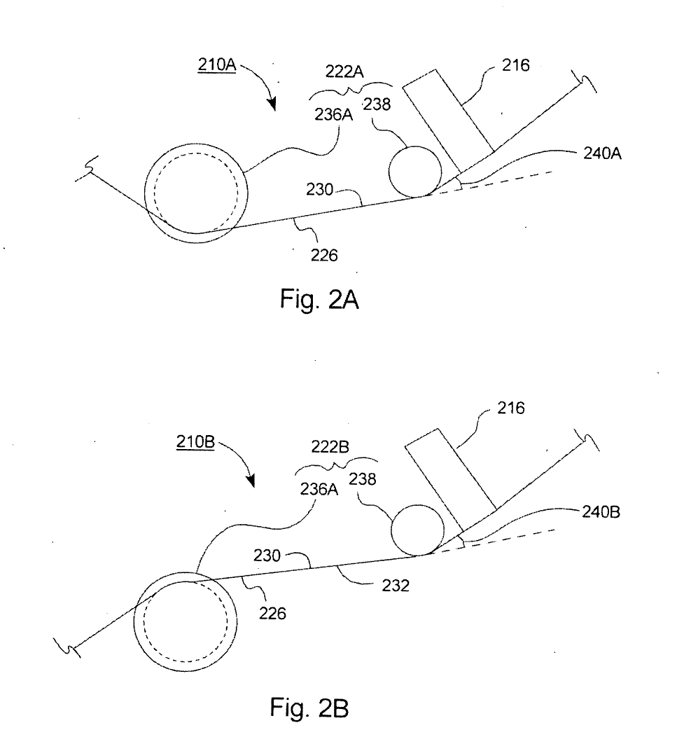

FIG. 2A is a simplified top view of a portion of the tape 226, and a portion of one embodiment of the tape drive 210A. In this embodiment, the tape drive 210A includes the head assembly 216 and one embodiment of the guide assembly 222A including the rotatable first roller 236A and the tape guide 238. In the embodiment illustrated in FIG. 2A, the first roller 236A, the tape guide 238 and the head assembly 216 are each positioned to contact the first side 230 of the tape 226. With this design, the tape 226 is more easily positioned during loading and unloading because each of these structures, i.e. the first roller 236A, the tape guide 238 and the head assembly 216 is positioned on the same side of the tape 226.

Additionally, in this embodiment, the tape 226 forms a relatively small tape wrap angle 240A at the tape guide 238. In one embodiment, the tape wrap angle 240A is less than approximately 30 degrees. In non-exclusive alternative embodiments, the tape wrap angle 240A is less than approximately 20 degrees, 15 degrees, 10 degrees, 5 degrees or 2 degrees. In still an alternative embodiment, the tape wrap angle 240A can be greater than 30 degrees.

Moreover, in one embodiment, the tape guide 238 can be substantially circular, and can have a diameter that is less than approximately 5 mm. In non-exclusive alternative embodiments, the tape guide 238 can have a diameter that is less than approximately 4 mm, 3 mm or 2 mm. In still another embodiment, the tape guide 238 can have a diameter that is greater than approximately 5 mm. In yet another embodiment, the tape guide 238 can have a non-circular shape. For example, in certain embodiments, because only a portion of the tape guide 238 contacts the tape 226 due to the non-rotation of the tape guide 238, the tape guide 238 can be elliptical, semi-circular or can have any other suitable configuration.

FIG. 2B is a simplified top view of a portion of the tape 226, and a portion of another embodiment of the tape drive 210B. In this embodiment, the tape drive 210B includes the head assembly 216 and another embodiment of the guide assembly 222B including the rotatable first roller 236A and the tape guide 238. In the embodiment illustrated in FIG. 2A, the first roller 236A, the tape guide 238 and the head assembly 216 are each positioned to contact the first side 230 of the tape 226. With this design, the tape 226 is more easily positioned during loading and unloading because each of these structures, i.e. the first roller 236A, the tape guide 238 and the head assembly 216 is positioned on the same side of the tape 226.

Additionally, in this embodiment, the tape 226 forms a relatively small tape wrap angle 2408 at the tape guide 238. In one embodiment, the tape wrap angle 240B is less than approximately 30 degrees. In non-exclusive alternative embodiments, the tape wrap angle 240B is less than approximately 20 degrees, 15 degrees, 10 degrees, 5 degrees or 2 degrees. In still an alternative embodiment, the tape wrap angle 240B can be greater than 30 degrees.

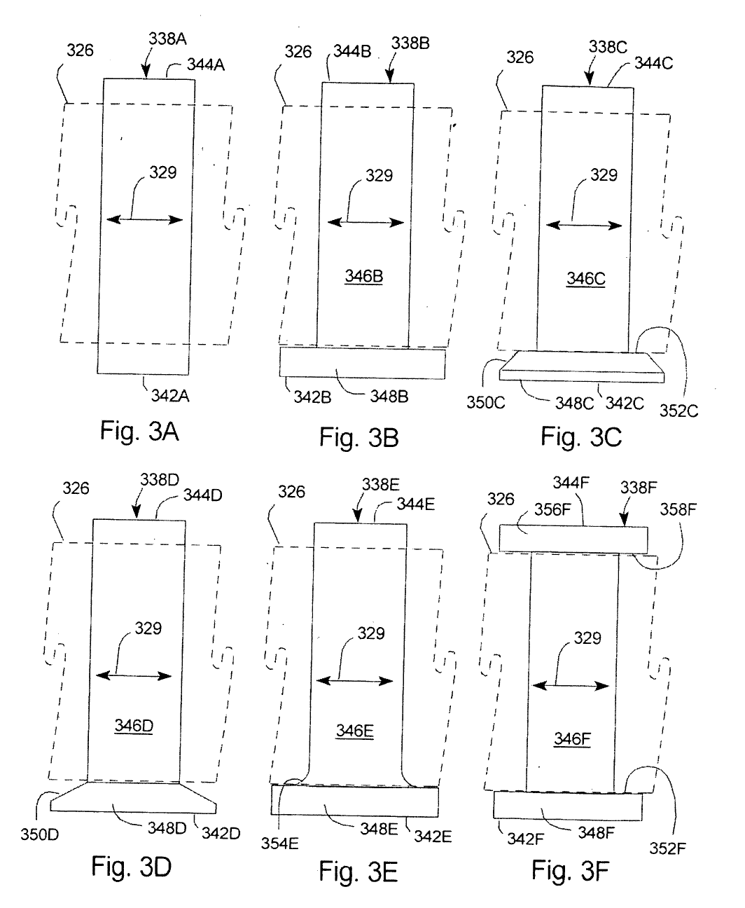

FIGS. 3A-3F illustrate various side views of different embodiments of the tape guide 338A-338F. Each tape guide 338A-338F is coupled or directly secured to the drive housing 14 (illustrated in FIG. 1). Further, each tape guide 338A-338F includes a corresponding proximal end 342A-342F that is secured to the drive housing 14, and a distal end 344A-344F that is not secured to the drive housing 14. In an alternative embodiment, the distal end 344A-344F can also be secured to the drive housing 14 at a different location from the proximal end 342A-342F.

FIG. 3A illustrates one embodiment of the tape guide 338A having a substantially cylindrical configuration. In this embodiment, the tape 326 (illustrated in phantom) moves against the tape guide 338A along the tape path 329 (indicated by bidirectional arrow). The dimensions of the tape guide 338A can vary. In one embodiment, the tape guide has a height that is at least as great as the width of the tape 326.

FIG. 3B illustrates another embodiment of the tape guide 338B having a substantially cylindrical core 346B and a first flange 348B. In this embodiment, the first flange 348B is substantially disk-shaped, and can have a substantially rectangular cross-section, as illustrated in FIG. 3B. In accordance with this embodiment, the tape 326 (illustrated in phantom) moves against the core 346B of the tape guide 338B, while simultaneously contacting the first flange 348B. Thus, in this embodiment, the first flange 348B can support the tape 326 as the tape 326 moves along the tape path 329. With this design, the first flange 348B can maintain the proper vertical position of the tape 326 as the tape 326 passes across the head assembly 16 (illustrated in FIG. 1), thereby reducing the likelihood and extent of LTM.

FIG. 3C illustrates another embodiment of the tape guide 338C having a substantially cylindrical core 346C and a first flange 348C. In this embodiment, the first flange 348C can include a chamfer 350C and a contact surface 352C, as illustrated in FIG. 3C. In accordance with this embodiment, the tape 326 (illustrated in phantom) moves against the core 346C of the tape guide 338C, while simultaneously contacting the contact surface 352C of the first flange 348C. Thus, in this embodiment, the first flange 348C can support the tape 326 as the tape 326 moves along the tape path 329. With this design, the first flange 348C can maintain the proper vertical position of the tape 326 as the tape 326 passes across the head assembly 16 (illustrated in FIG. 1), thereby reducing the likelihood and extent of LTM.

FIG. 3D illustrates another embodiment of the tape guide 338D having a substantially cylindrical core 346D and a first flange 348D. In this embodiment, the first flange 348D can include a chamfer 350D that slopes substantially downward away from the core 346D, as illustrated in FIG. 3D. In accordance with this embodiment, the tape 326 (illustrated in phantom) moves against the core 346D of the tape guide 338D, while simultaneously contacting the chamfer 350D of the first flange 348D. Thus, in this embodiment, the first flange 348D can support the tape 326 as the tape 326 moves along the tape path 329. Further, because of the chamfer 350D, buckling of the tape 326 can be inhibited or eliminated. With this design, the first flange 348D can maintain the proper vertical position of the tape 326 as the tape 326 passes across the head assembly 16 (illustrated in FIG. 1), thereby reducing the likelihood and extent of LTM.

FIG. 3E illustrates another embodiment of the tape guide 338E having a substantially cylindrical core 346E and a first flange 348E. In this embodiment, the first flange 348E can include a curved support surface 354E that gradually slopes substantially downward away from the core 346E, as illustrated in FIG. 3E. In accordance with this embodiment, the tape 326 (illustrated in phantom) moves against the core 346E of the tape guide 338E, while simultaneously contacting the curved support surface 354E of the first flange 348E. Thus, in this embodiment, the first flange 348E can support the tape 326 as the tape 326 moves along the tape path 329. Further, because of the curved support surface 354E, buckling of the tape 326 can be inhibited or eliminated. With this design, the first flange 348E can maintain the proper vertical position of the tape 326 as the tape 326 passes across the head assembly 16 (illustrated in FIG. 1), thereby reducing the likelihood and extent of LTM.

FIG. 3F illustrates another embodiment of the tape guide 338F having a substantially cylindrical core 346F, a first flange 348F and a second flange 356F. In this embodiment, the first flange 348F can include a first contact surface 352F, and the second flange 356F can include a second contact surface 358F. In one such embodiment, the distance between the first contact surface 352F and the second contact surface 358F is substantially similar to the width of the tape 326. In accordance with this embodiment, the tape 326 (illustrated in phantom) moves against the core 346F of the tape guide 338F, while simultaneously contacting the first contact surface 352F of the first flange 348F and the second contact surface 358F of the second flange 356F. Thus, in this embodiment, the first flange 348F and the second flange 356F can maintain the proper vertical positioning of the tape 326 as the tape 326 moves along the tape path 329, thereby reducing the likelihood and extent of LTM.

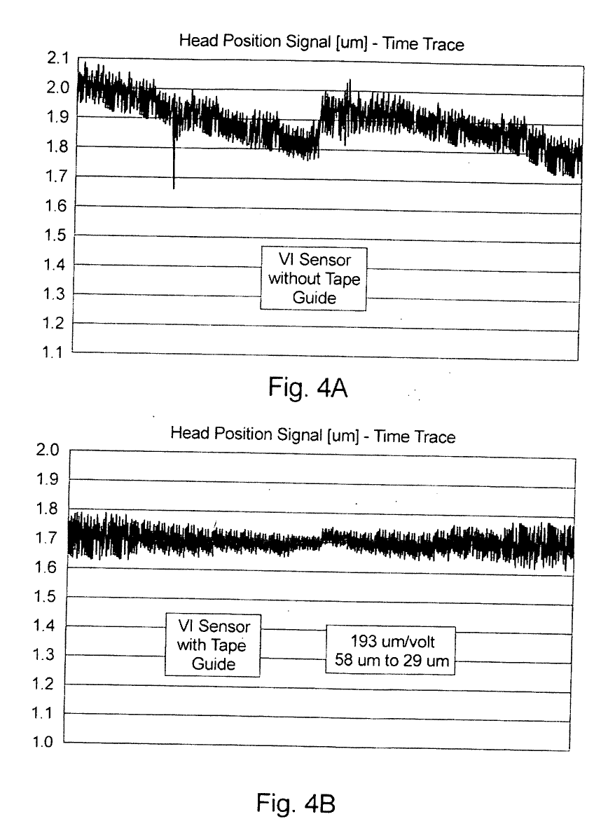

FIG. 4A is a graph illustrating experimental results of a head position signal over time in the absence of a guide assembly having features of the present invention. In FIG. 4A, the graph shows that the head position signal varies to a significant extent over time, as indicated by a sensor which monitors the extent of vertical movement of the tape head. In other words, the more variation in the vertical adjustment of the tape head that is detected by the sensor, the more LTM is occurring. In this embodiment, a variable inductance (VI) sensor was utilized. However, it is understood that other suitable types of sensors could be utilized during this type of experimentation process.

FIG. 4B is a graph illustrating experimental results of the head position signal over time using one embodiment of the guide assembly having features of the present invention. As illustrated in FIG. 4B, the variation of the head position signal is reduced, and is more constant than that illustrated in FIG. 4A. Stated another way, vertical adjustment of the tape head has been reduced, which is indicative of a corresponding reduction in LTM.

While the particular tape drive 10 and guide assembly 22 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A guide assembly for guiding movement of a tape past a head assembly in a tape drive, the tape moving along a tape path, the tape having a first side that contacts the head assembly and an opposing second side, the guide assembly comprising:
a rotatable roller that guides the tape along the tape path; and
a non-rotatable tape guide that guides the tape along the tape path, the tape guide being positioned to contact the first side of the tape, the tape guide being positioned between the rotatable roller and the head assembly relative to the tape path.

2. The guide assembly of claim 1 wherein the tape guide includes a first flange that contacts the tape during movement of the tape along the tape path.

3. The guide assembly of claim 2 wherein the tape drive includes a housing, and the tape guide includes a proximal end that is secured to the housing.

4. The guide assembly of claim 3 wherein the first flange is positioned near the proximal end.

5. The guide assembly of claim 4 wherein the tape guide includes a distal end opposite the proximal end, and a second flange that is positioned near the distal end.

6. The guide assembly of claim 5 wherein the tape moves along the tape path substantially between the first flange and the second flange.

7. The guide assembly of claim 1 wherein the tape guide is positioned more closely to the head assembly than the tape guide is to the rotatable roller.

8. The guide assembly of claim 1 wherein the tape guide is movable in a direction that is approximately perpendicular to the direction of the tape path.

9. The guide assembly of claim 1 wherein the tape drive includes a drive housing, and the tape guide is fixed relative to the drive housing.

10. The guide assembly of claim 1 wherein the tape forms a tape wrap angle relative to the tape guide that is less than approximately 20 degrees.

11. The guide assembly of claim 1 wherein the tape forms a tape wrap angle relative to the tape guide that is less than approximately 10 degrees.

12. The guide assembly of claim 1 wherein the rotatable roller is positioned to contact the second side of the tape.

13. The guide assembly of claim 1 wherein the rotatable roller is positioned to contact the first side of the tape.

14. The guide assembly of claim 1 wherein the tape guide is positioned less than approximately 5 mm from the head assembly.

15. The guide assembly of claim 1 wherein the tape path is uninterrupted between the rotatable roller and the tape guide.

16. A method for guiding a tape along a tape path across a head assembly in a tape drive, the method comprising the steps of:
positioning a non-rotatable tape guide between a rotatable roller and the head assembly relative to the tape path; and
guiding the tape along the tape path with the rotatable roller and the tape guide so that the tape guide and the head assembly each contacts a first side of the tape.

17. The method of claim 16 wherein the step of guiding includes positioning a first flange on the tape guide so that the tape contacts the first flange during movement of the tape along the tape path.

18. The method of claim 16 wherein the step of positioning includes positioning the tape guide more closely to the head assembly than the tape guide is to the rotatable roller.

19. The method of claim 16 wherein the step of positioning includes forming a tape wrap angle relative to the tape guide that is less than approximately 20 degrees.

20. The method of claim 16 wherein the step of positioning includes positioning the tape guide less than approximately 5 mm from the head assembly.

21. The method of claim 16 wherein the step of positioning includes the tape path being uninterrupted between the rotatable roller and the tape guide.

22. A guide assembly for guiding movement of a tape past a tape head in a tape drive, the tape moving along a tape path, the tape having a first side that contacts the tape head and an opposing second side, the guide assembly comprising:
a rotatable roller that guides the tape along the tape path; and
a non-rotatable tape guide that guides the tape along the tape path, the tape path being uninterrupted between the rotatable roller and the tape guide, the tape guide being positioned to contact the first side of the tape, the tape guide being positioned between the rotatable roller and the tape head relative to the tape path, the tape guide including a flange that supports the tape during movement of the tape along the tape path, the tape guide being positioned more closely to the head assembly than the tape guide is to the rotatable roller, the tape forming a tape wrap angle relative to the tape guide that is less than approximately 20 degrees.
